(19) United States
(12) Patent Application Publication
(10) Pub. No.: US 2012/0324390 A1
(43) Pub. Date: Dec. 20, 2012

(54) SYSTEMS AND METHODS FOR A VIRTUAL WATCH

(76) Inventor: Richard Tao, Webster Groves (US)

(21) Appl. No.: 13/524,720

(22) Filed: Jun. 15, 2012

Related U.S. Application Data
(60) Provisional application No. 61/497,802, filed on Jun. 16, 2011.

(51) Int. Cl. G06F 3/048

(52) U.S. Cl. 715/771

(57) ABSTRACT

The present application generally relates to a virtual watch having a processing device and an input device. In particular, the present application relates to virtual watch system and method that enables users to access and modify pre-set watch designs stored on the virtual watch and add custom watch designs. Additionally, aspects of the present invention enables users of the virtual watch system and method to share watch designs with other remote processing devices.

### RELATED APPLICATIONS

This application takes priority to U.S. Patent Application No. 61/497,802, filed Jun. 16, 2011, and entitled Systems and Methods for a Virtual Watch, the entire contents of which are incorporated herein by reference.

### FEDERALLY SPONSORED RESEARCH OR DEVELOPMENT

Not Applicable.

### COMPACT DISK APPENDIX

Not Applicable.

### FIELD

The present application relates to digital watches and in particular, a digital watch device that allows a user to select a watch type and select a watch face of the digital watch.

### BACKGROUND

Analog and digital wrist watches have been accepted as a mainstream method for providing mobile time-keeping functions to individuals for many years. Typically, an analog or digital watch is worn on the body, such as the wrist, and provides the user with immediate access to time and time related information. Moreover, while the main purpose of wrist watches is to provide the user with time related information, many individuals select wrist watches based on personal style, fashion, and identity. Accordingly, the design, display, and appearance of wrist watches are all important aspects of a watch to users.

Generally, wrist watches inform the user of the time by using either the position of hands pointed to specific numbers or by displaying the time digitally in absolute value numeric form. Some wrist watches include a digital display that may display graphic images created via a computer. However, these conventional watches are limited in regard to their display capabilities because the watch faces and watch designs are static and unchangeable. Thus, if a user wanted a wrist watch with a different design or display, the user would have to purchase multiple, different, watches.

### SUMMARY

According to one aspect, a virtual watch device is provided for displaying a virtual watch design. The virtual watch device includes a housing, a display screen, at least one communication port operatively connected to the housing, at least one processor; at least one input device. The device also includes a memory for storing a memory storing watch design data for a plurality of watch design. Each of the plurality of watch designs includes a plurality of watch components. The watch design data includes one or more watch feature types and one or more feature attributes for each of the plurality of watch components. The device also includes a virtual watch application that includes modules executable by the at least one processor.

A modification module to display a list of the plurality of watch designs via a graphical user interface at the display screen in response to an update request. The modification module also receives a first input corresponding to a first selection of a particular one of the plurality of watch designs being displayed, receives a second input corresponding to a second selection of a feature type for at least one of the plurality of watch components of the particular watch design, and receives a third input corresponding to a third selection of a feature attribute for each feature type selection. The modification module also stores each feature type and each feature attribute selected for the particular watch design in the memory. A watch design retrieval module retrieves watch design data for the particular one of the plurality of watch designs from the memory in response to a retrieval request. The retrieval request identifies the particular watch design selected, each feature type selected, and each feature attribute selected. A GUI module displays the particular watch design selected with each selected feature type and each selected feature attribute via the graphical user interface.

According to another aspect, a method is provided for displaying a virtual watch design via a virtual watch. The virtual watch includes a housing, a display screen, a processing device, at least one input device, and at least one communication port. The method includes retrieving a plurality of watch designs from a memory for display via in response to an update request. The method includes displaying a list of the plurality of watch designs via a graphical user interface at the display screen in response to an update request. The method also includes receiving a first input corresponding to a first selection of a particular one of the plurality of watch designs being displayed, receiving a second input corresponding to a second selection of a feature type for at least one of the plurality of watch components of the particular watch design, and receiving a third input corresponding to a third selection of a feature attribute for each feature type selection.

The method also includes storing each feature type and each feature attribute selected for the particular watch design in the memory. The method also retrieving watch design data for the particular one of the plurality of watch designs from the memory in response to a retrieval request. The retrieval request identifies the particular watch design selected, each feature type selected, and each feature attribute selected. The method further includes displaying the particular watch design selected with each selected feature type and each selected feature attribute via the graphical user interface.

### BRIEF DESCRIPTION OF THE DRAWINGS

FIG. 1 is a block diagram of a computing environment for generating virtual watch designs according to one aspect of the virtual watch system.

FIGS. 2A-2B depict a front and side view of an example embodiment of a virtual watch to which aspects of the virtual watch may be applied.

FIGS. 3-6A are example virtual watch menus displayed according to aspects of the virtual watch system.

FIG. 6B is example color palette displayed according to aspects of the virtual watch system.

FIGS. 7A-70 are exemplary watch designs displayed by the virtual watch system.

FIGS. 8-9 are additional example virtual watch menus displayed according to aspects of the virtual watch system.

FIG. 10 is a block diagram of a virtual watch application according to one aspect of the virtual watch system.

FIG. 11 is a block diagram of a database according to one aspect of the virtual watch system.

FIG. 12 is an example method for according to one aspect of the virtual watch system.

### DETAILED DESCRIPTION

Aspects of a virtual watch system and method allow users to generate various watch designs for display via a virtual watch. For example, the virtual watch system provides users with the ability to display a pre-set watch design stored in the virtual watch and subsequently modify various displayed components of the pre-set watch design. Moreover, the virtual system enables a user to modify feature data associated with various components to customize a particular design and/or display multiple permutations of a particular customized design.

Other aspects of the virtual watch system allow users to share and transfer watch designs. For example, the virtual watch system provides users with the ability to transfer watch designs from the virtual watch to a remote processing device, such as another virtual watch.

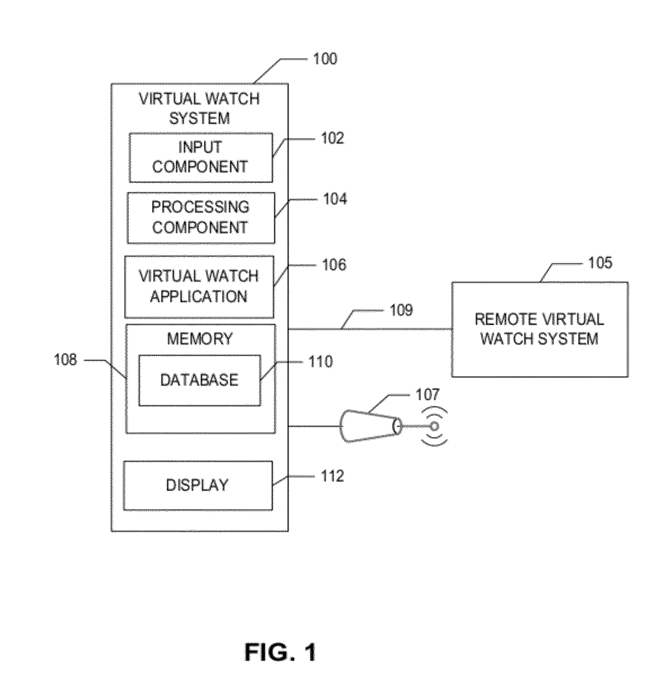

FIG. 1 is a block diagram of an exemplary virtual watch system 100 and illustrates various hardware and software components used to implement aspects of the system. In this example, the virtual watch system 100 includes an input component 102, a processing component 104, a remote virtual watch system 105, a transmitter 107, and a display 112. Although referred to as a virtual watch system 100, it is contemplated that a virtual watch system 100 can be embodied in within an apparatus or device that can be worn on the body, such as the wrist.

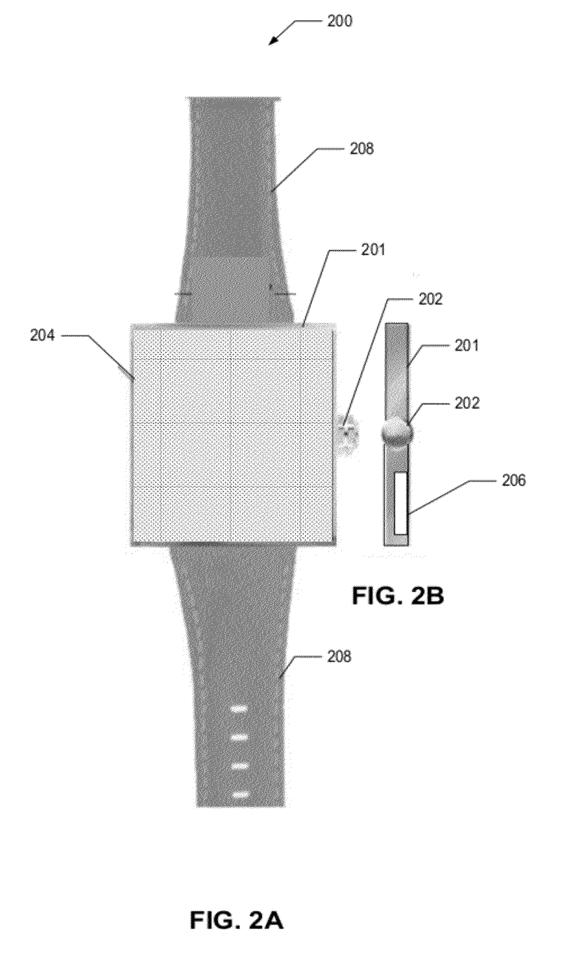

According to one aspect, the input component 102 is a hardware component operatively connected to the processing device that may be manipulated by a user to control the functions of the processing component 104. For example, the input component 102 may be a control knob as described below in reference to FIG. 2. In another aspect, the input component 102 may be a crown, a manually operable push button, a keypad, a pointing device (e.g., a mouse, trackball, and pen) or any other type of input device physically and operatively connected to the processing component 104.

The processing component 104 is capable of performing particular functions of the virtual watch system 100, as will be further described below. The processing component 104 includes one or more processors that process software or other machine-readable instructions. Additionally, the processing component 104 includes a memory 108 and a database 110 to store software or other machine-readable instructions and data, necessary to perform the particular functions of the virtual watch system 100. The memory 108 may include volatile and/or non-volatile memory. The processing component 104 executes a virtual watch application 106 that allows a user to access and view pre-set virtual watch designs, modify pre-set watch designs, and/or create new virtual watch designs.

According to one aspect, the processing component 104 transfers virtual watch data and/or virtual watch designs to the remote virtual watch system 105 wirelessly via the transmitter 107. The transmitter 107 may utilize a Gigabit Ethernet link, IEEE 802.11 link, Ultra-Wide Band (UWB) link, or any other suitable wireless communication link.

According to another aspect, the processing component 104 transfers virtual watch feature data and/or virtual watch designs to the remote virtual watch system 105 via a wired connection 109. The wired connection 109 can be a USB connection, a FireWire connection, or any other suitable wired connection.

The processing component 104 is operatively connected to the display 112, such as a light emitting diode screen (LED), a liquid crystal display (LCD), a computer monitor, a digital display, or any other type of electronic display for displaying virtual watch data, virtual watch menus, and/or virtual watch designs. According to one aspect, the display 112 displays a graphical user interface 114 that enables a user to interact with the virtual watch application 106 that allows a user to access and view pre-set virtual watch designs, modify pre-set watch designs, and/or create new virtual watch designs. For example, as explained in more detail below, the display is a touch screen display that enables a user to interact with the graphical user interface 114 via an input tool, such as stylus or finger.

FIGS. 2A and 2B illustrate a front and side view of a virtual watch device 200 to which aspects of the virtual watch system 100 may be applied. The virtual watch device 200 includes a housing 201 that houses the processing component 104, a control knob 20n a2 (e.g., input component 102), a display 204 in a square configuration (e.g., display 108), a communication port 206 and two straps 208 hinged to respective opposite ends of the housing that operate to securely wrap around the wrist of the watch wearer.

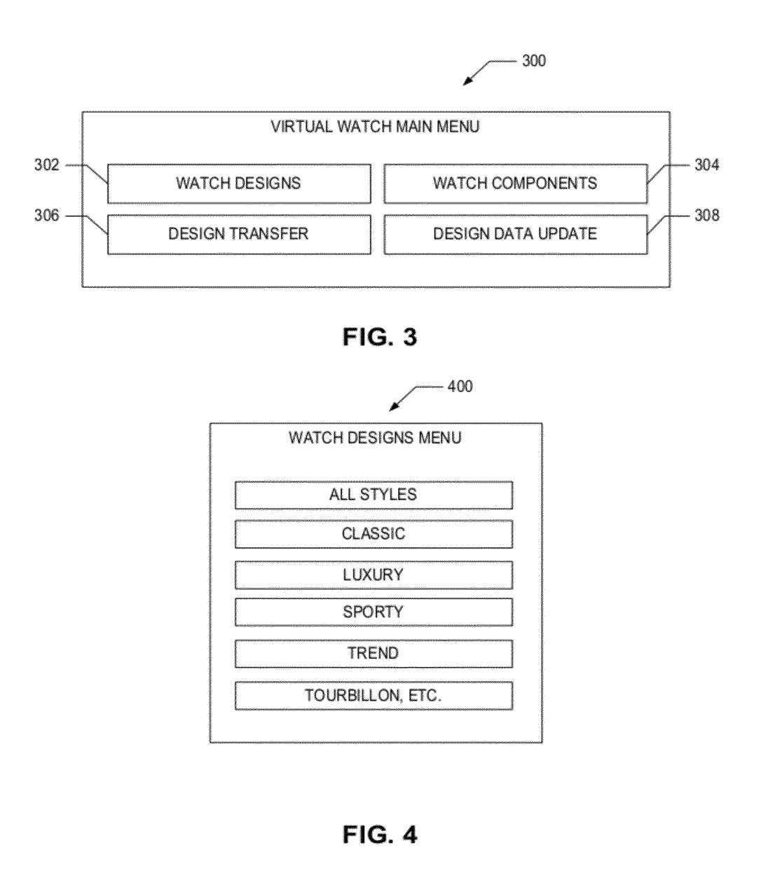

According to one aspect, the user of the virtual watch device 200 interacts with the control knob 202 to display a main menu on the display screen 204. Alternatively, the user may interact directly with the display screen 112 (e.g., touch display screen) during the display of a current watch design to display the main menu. Thereafter, the user interacts with the main menu to select from a list options to view and/or modify virtual watch designs and to share virtual watch designs. For example, the main menu includes a “watch design” selection option, a “watch components” selection option, a “design transfer” option, and a “design data update” option. It is contemplated that the main menu may include additional options in other aspects. A screen shot of an exemplary main menu 400 is depicted in FIG. 3.

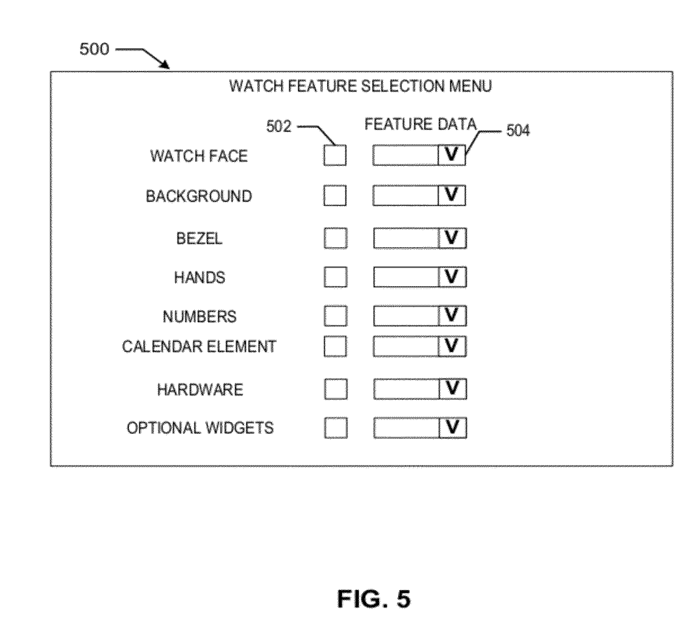

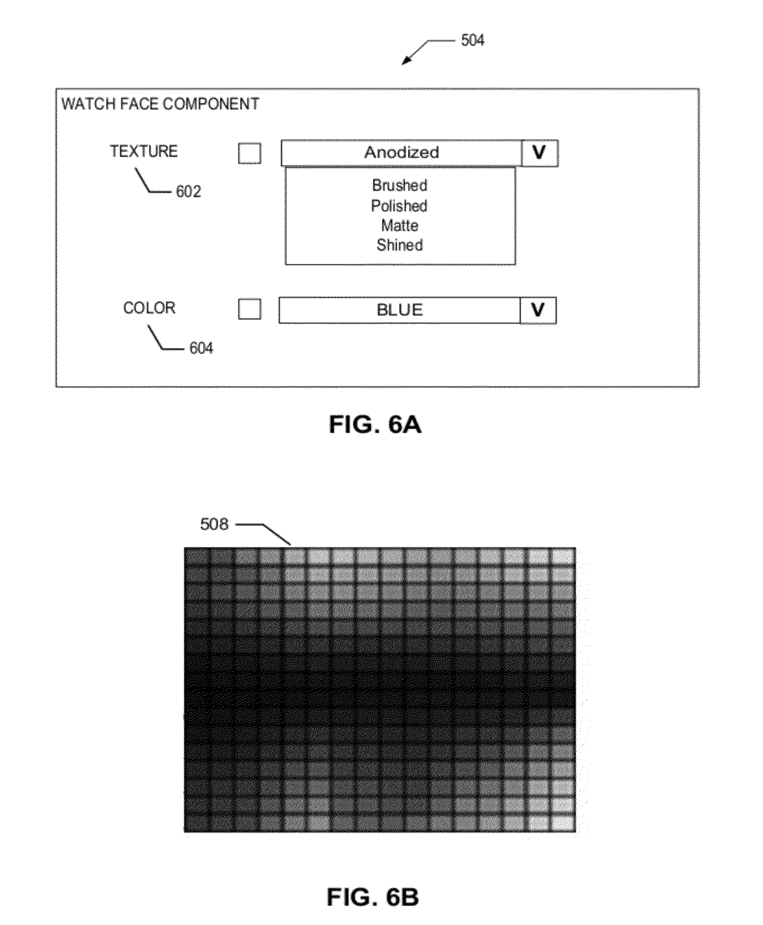

Each of the menu options in the main menu corresponds to a particular sub menu. For example, the watch design selection option, the watch component selection option, the design transfer option, and the design data update option correspond to a watch design selection menu, a watch component selection menu, a design transfer menu, and design data update menu respectively. Accordingly, the user can interact with the main menu 300 via the control knob 202 to display a desired one of the menus FIG. 3, FIG. 4, FIG. 5, and FIG. 6. As an example, a user may rotate the control knob 202 in a downward direction, to scroll down through a list of the menu options in the main menu 300. Alternatively, the user may rotate the control knob in an upward direction, to scroll up through the list of menu options. To select a particular menu or menu option, a user may stop rotating the control knob when the particular menu option is highlighted and depress the control button inward.

According to another aspect, the user may interact directly with the display 112 to display a desired one of the menus FIG. 3, FIG. 4, FIG. 5, and FIG. 6. As an example, the display is a touch screen that is responsive to a user's finger or other instrument to generate an input or command that is processed by the virtual watch application. For example, a user swipes a finger across the main menu in a downward direction to scroll down through a list of the menu options in the main menu 300. Alternatively, the user may swipe the finger in an upward direction, to scroll up through the list of menu options. To select a particular menu or menu option, the user may perform double tap with his or her finger on the particular menu.

Although the input device 202 is described herein as a control knob, it is contemplated that in other embodiments the control knob 202 may be, as noted above, any type of input device operatively connected to the processing component 104A. For example, in an alternative embodiment, the control knob 202 may be a manual push button. In such an embodiment, a user may manually depress the push button one or more times to scroll, select, and highlight various virtual watch menus. In addition it is contemplated that

Moreover, although the virtual watch system 100 is described below herein as receiving inputs or commands from user interaction with the control knob 202, it is also contemplated that that virtual match system 100 is configured to receive user input via gestures (finger swipes, single taps, double taps, etc.) sensed at the display (e.g., touch screen display).

FIG. 4 depicts a watch designs selection menu 400 that is displayed at the display screen when the user selects the watch design selection option 302 via the main menu 300. The watch design selection menu 400 enables a user to select a particular watch design from a list of the available watch designs included in the database 110. For example, the user of the virtual watch device uses the control knob 202 to scroll or navigate through the list of the available watch designs displayed via the watch design selection menu 400 to highlight a particular watch design. The user then depresses the control knob 202 to select the highlighted watch design. Thereafter the selected watch design is displayed on the display screen 204.

FIG. 5 depicts a component type selection menu 500 that is displayed via the display screen 204 in response to the user selecting the watch components selection option 304 via the main menu 300. The component type selection menu 500 includes drop down controls that enables a user to select feature data, such as a feature type for one or more watch components that are available for the selected watch type and are included in the database 108. Examples of feature types include a watch face type, a background theme, a bezel type, an hour hand type, a minute hand type, a second hand type, a numbers type, a calendar type, and hardware type (e.g., screw type).

As a particular example, the user of the virtual watch device 200 can use the control knob 202 to interact with the component type selection menu 500 to scroll or navigate through various watch components that are available for the selected watch type and select a particular watch component, such as the watch face component by highlighting a selection control 502 adjacent to the watch face label. After using the control knob 202 to scroll through the various watch faces in the dropdown feature attribute selection menu 504, the user then depresses the control knob 202 in an inward direction, to select a particular highlighted watch face from the dropdown menu. After the watch face component has been selected by the user, the user may select a specific feature attribute of the watch face component for the design using a feature attribute selection menu 504.

FIG. 6A depicts an example feature attribute selection 504 that is displayed in response to a selection of the watch face component via the watch feature selection menu and illustrates examples of feature attributes that may be selected by a user. Feature attributes include, for example, texture 602 and color 604. A selected texture 602 may include a brushed finish, polished finish, a matte finish, a shine finish, or textured appearance.

After the watch face component has been selected by the user, the feature attribute selection menu 504 also enables a user to select a specific color for that watch face component using the dropdown menu 506. In other words, a color can be selected for each of watch face type, background, a bezel, an hour hand, a minute hand, a second hand, a numbers, etc. As a result, the feature attribute selection menu 504 enables a user to select a particular color for each watch component to “colorize” a particular watch design such that the same watch design can have a plurality of color permutations. Stated differently, watch designs that have the same feature types for their various watch components, may each still have different appearances due to different color and/or texture selections for each component.

According to another aspect, the user initiates the selection of a desired color for a particular component by double tapping that particular component with his or her finger or stylus to assign a color attribute. In this aspect, the display 204 is a touch screen such that the virtual watch application responsive to the double tap user's finger or other instrument to generate a color palette on the display. A color palette 606, such as shown in FIG. 6B, displays primary colors and several shades formed by blends of the primary colors to enable the user to select a desired color. After the user selects (via the touch screen or control knob) a color from the color palette 606, the particular selected component is assigned or designated that color.

According to another aspect, after the user selects a color from the color palette 606 and the particular component is assigned that color, the user can change the shade or hue of the designated color via a swipe motion across the display. The user accepts, a particular shade or hue of designated color, by double tapping that particular component. It is contemplated that different combinations of swipes and/or taps may be used to assign or designate colors for various watch components in other aspects of the virtual watch system.

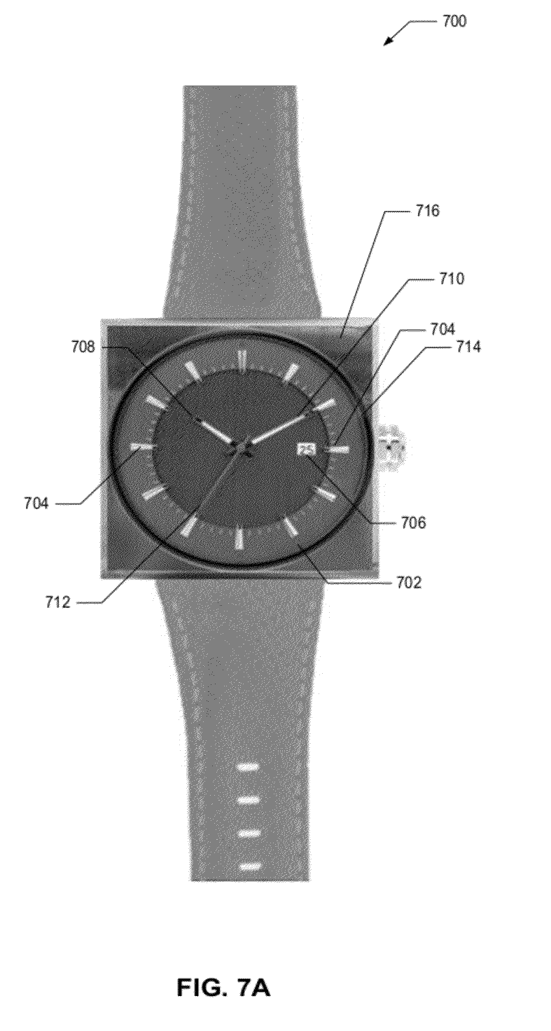

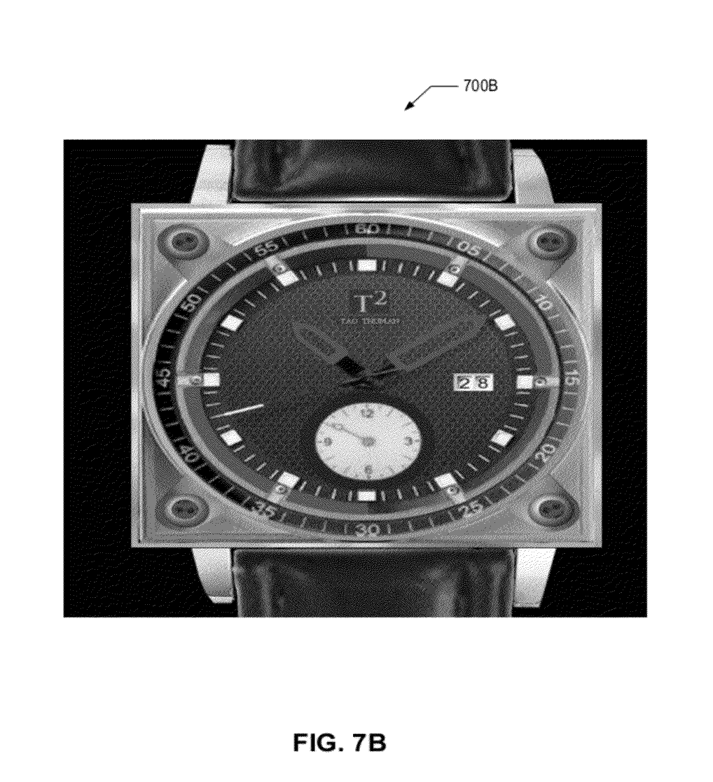

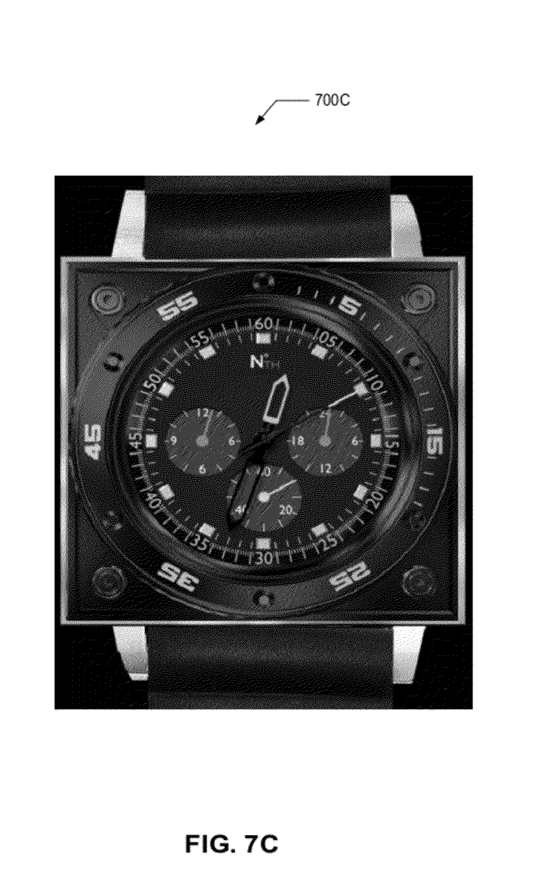

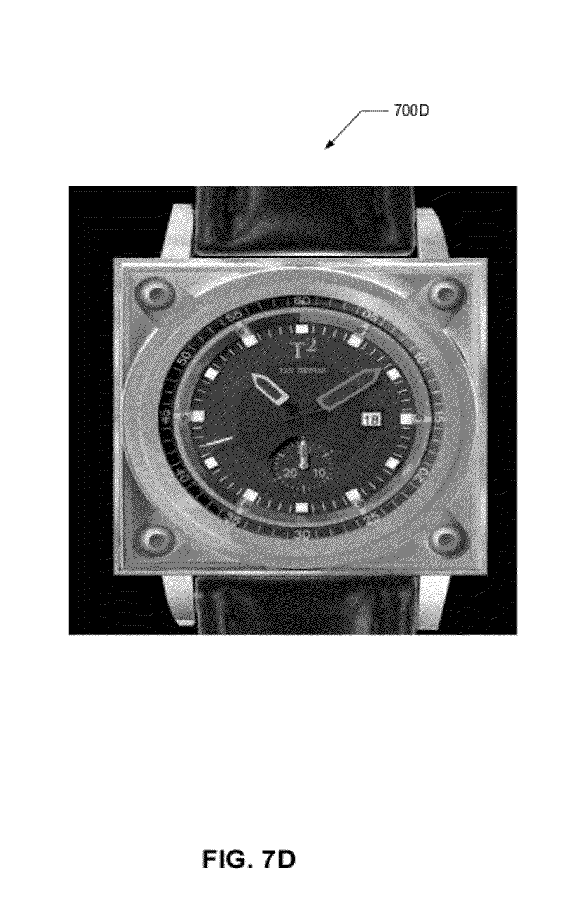

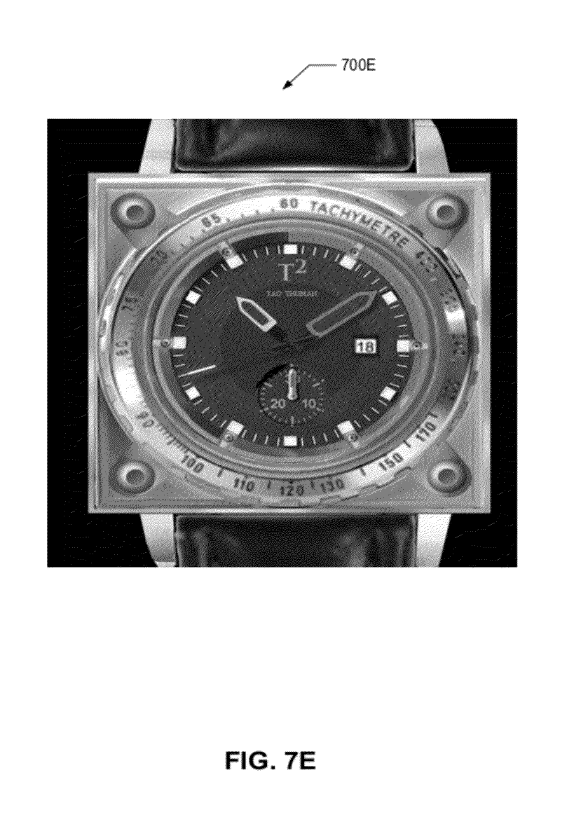

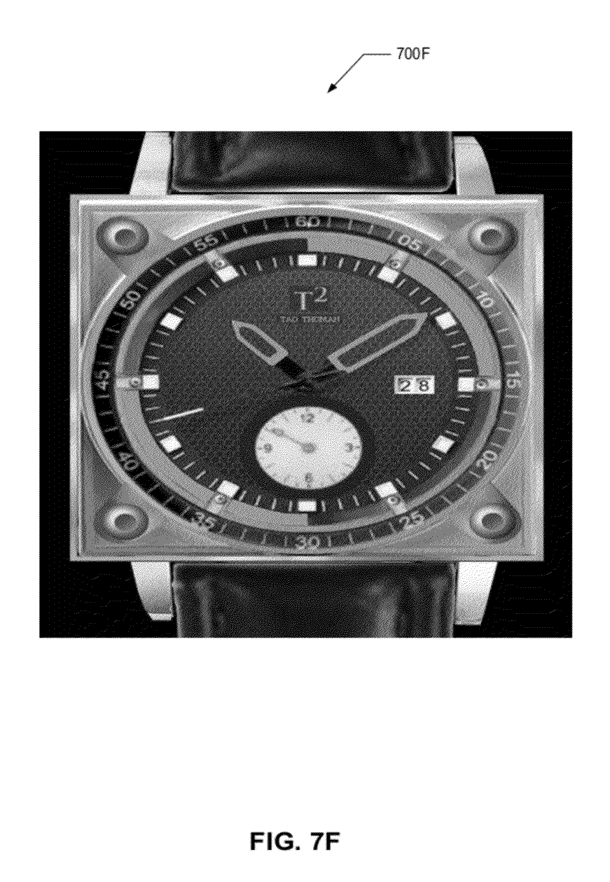

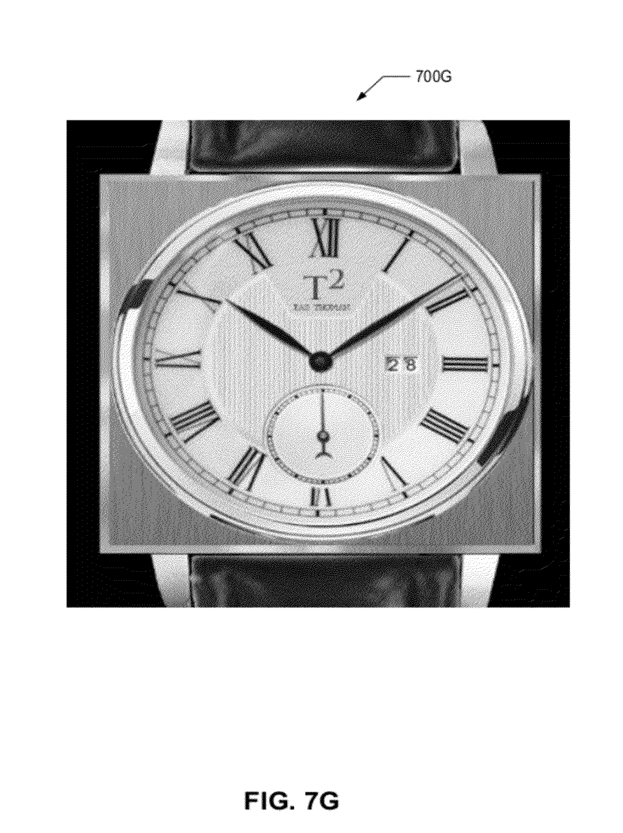

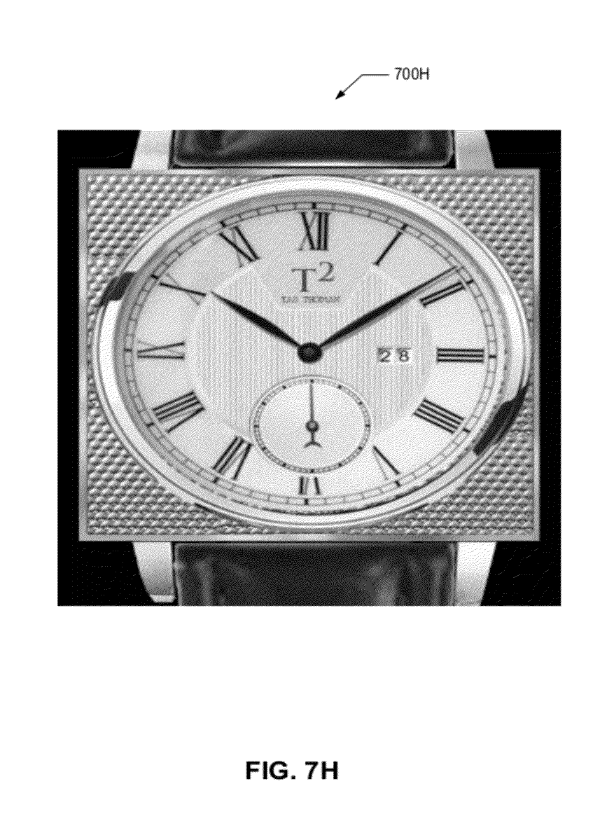

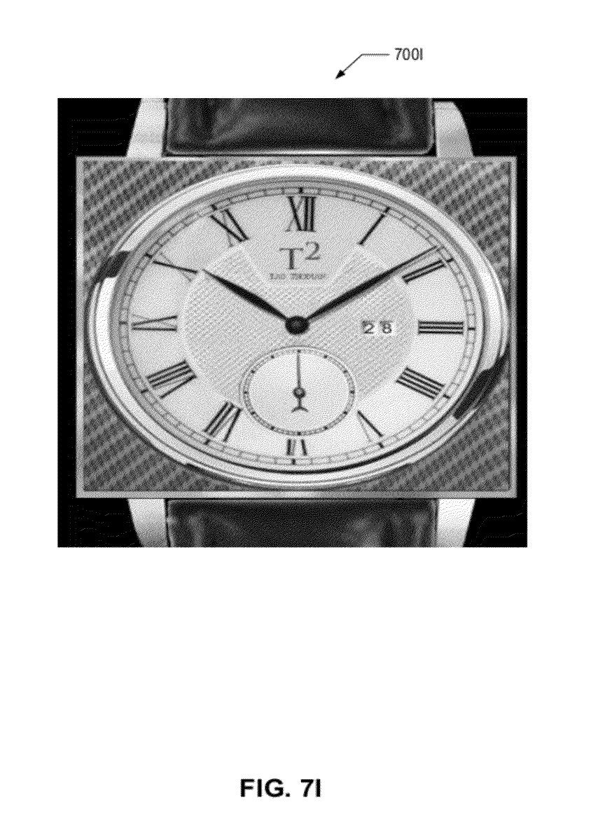

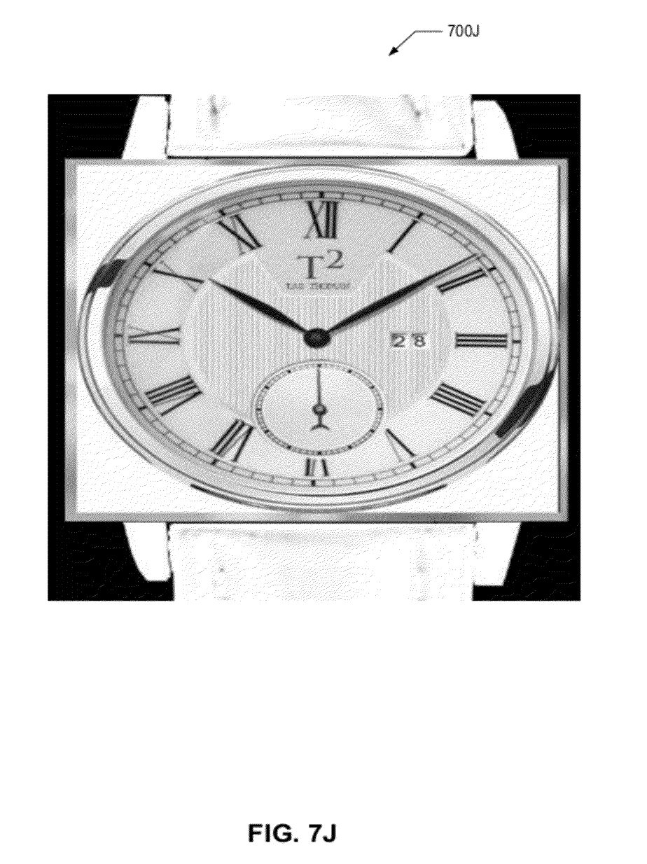

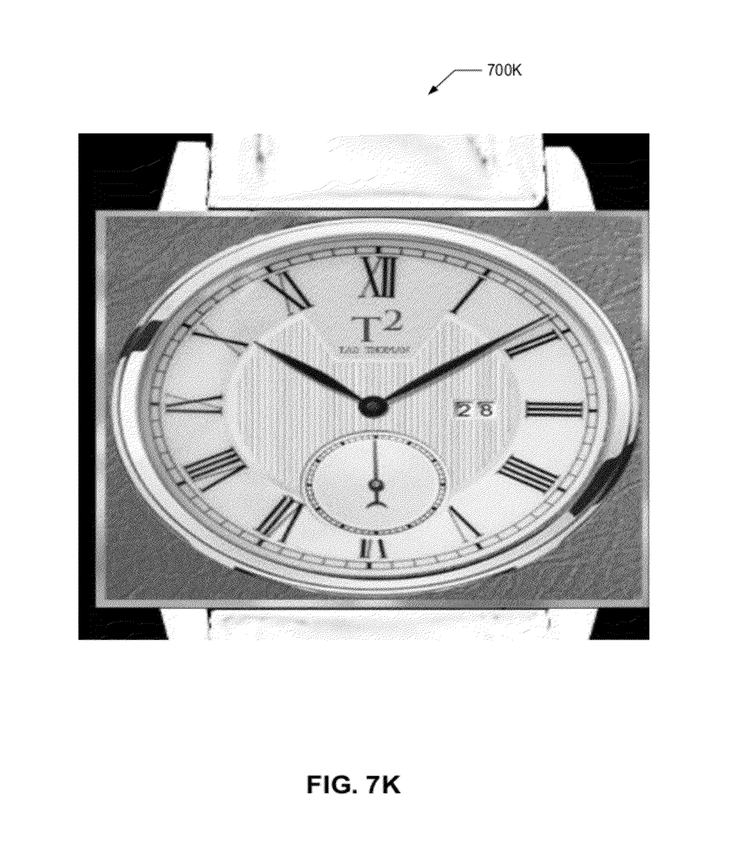

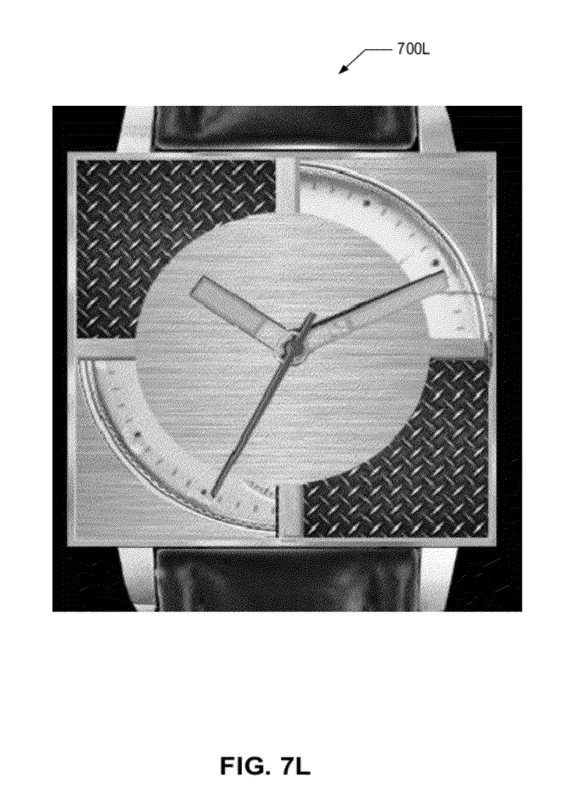

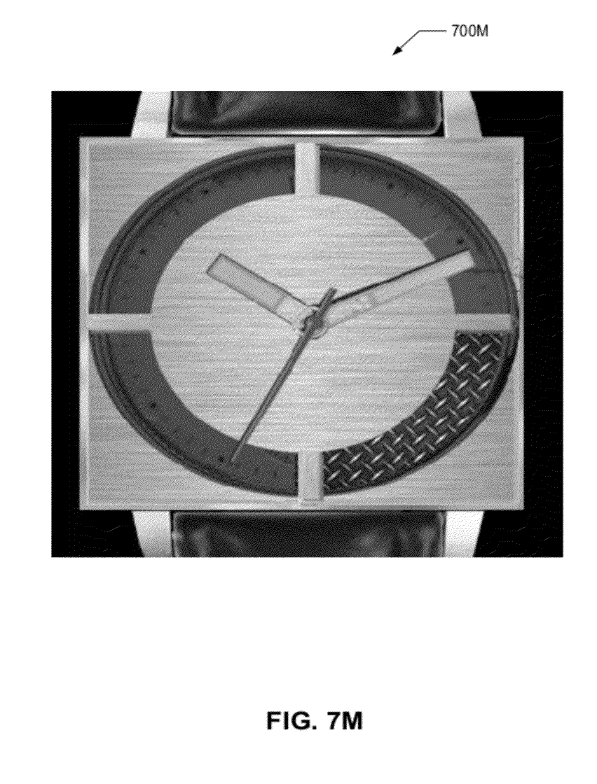

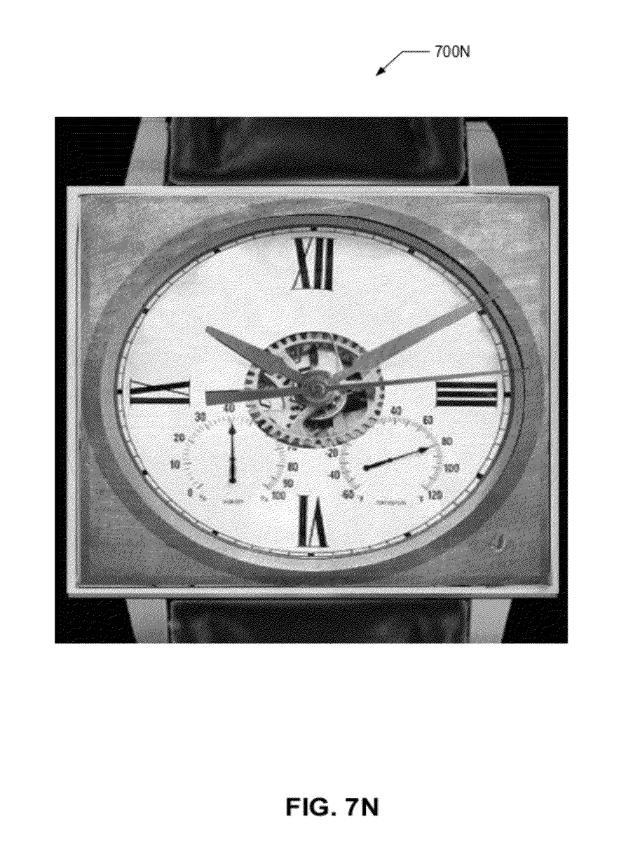

After the user has interacted with the component type selection menu 500 and the feature attribute selection 504, and/or a custom virtual watch design that includes selected feature types may be displayed on the display 108, such as the exemplary custom watch design 700 illustrated in FIG. 7A.

According to the exemplary embodiment depicted in FIG. 7A, the displayed custom watch design 700 includes a dial 702 with time markings 704 and a calendar date 706. The custom watch design 700 also includes an hour hand 708, a minute hand 710, a second hand 712, a bezel 714, and a background theme 716 (e.g., area surrounding the bezel).

FIGS. 7B-7F illustrate various other watch designs with different design features for the watch face component that a user may create using the component type selection menu 500. In yet another example, FIGS. 7G-7O illustrate various watch designs that have similar watch faces but different design features for the background 716.

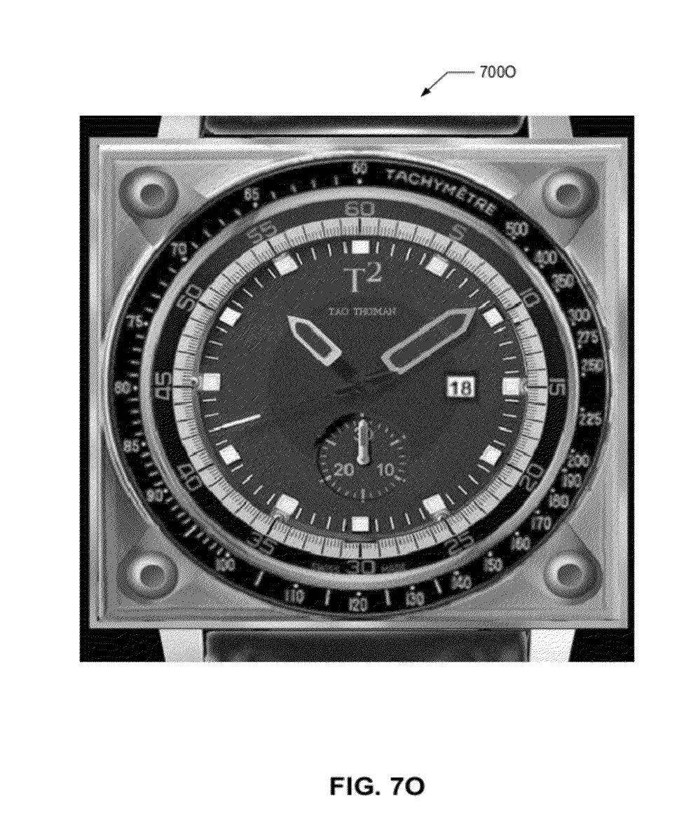

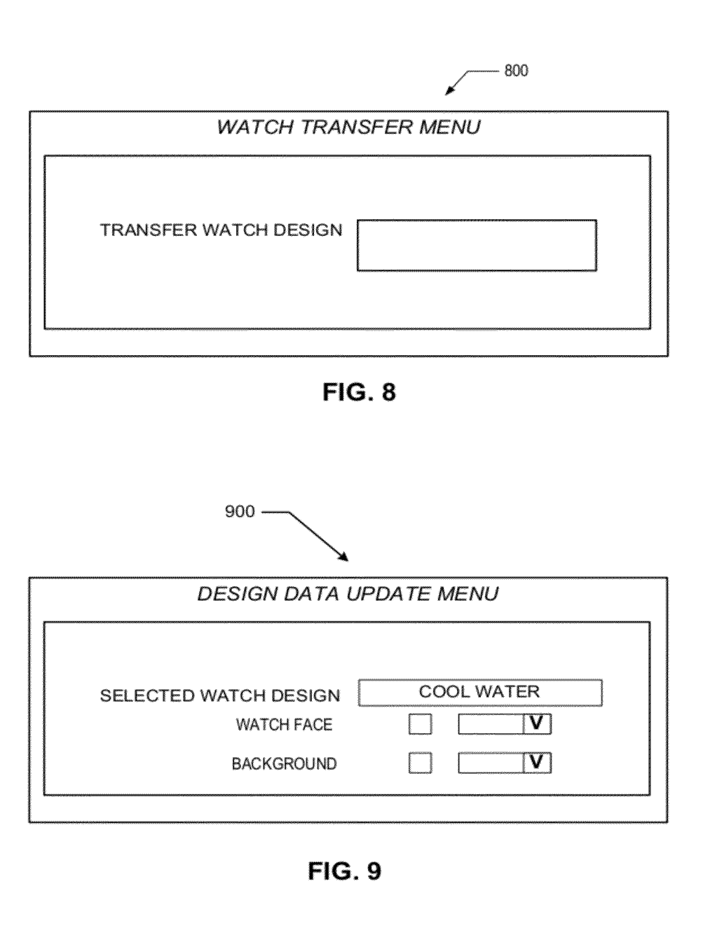

FIG. 8 depicts a design transfer menu 800 that is displayed via the display screen 204 when the user selects the design transfer option 306 via the main menu 400. The design transfer menu 800 enables a user to select a particular virtual watch design to transfer to a remote virtual watch system 105. For example, the user of the virtual watch device 200 uses the control knob 202 to scroll or navigate through the list of the available watch designs via the watch design selection menu 400 to highlight a particular watch design. Subsequently, the user uses the control knob 202 to select the design transfer option 406 to transfer the selected watch design to the remote virtual watch system 105. According to one aspect, the watch design is transferred to the remote virtual watch system 105 via the communication port 206. According to one aspect, the communication port 206 is configured to transfer watch data and watch designs to the remote virtual watch system 105 via a universal serial bus (“USB”) cable.

FIG. 9 depicts a design data update form 900 that is displayed via the display screen 204 when the user selects the design data update option 308 via the main menu 400. The design data update menu 900 enables a user to modify and/or add watch type data and/or watch component data. For example, the user of the virtual watch device 200 uses the control knob 202 to scroll or navigate through the list of the available watch designs via the watch design selection menu 400 to highlight a particular watch design to update. According to one aspect, the list of the available watch designs includes a new watch designs. Subsequently, the user uses the control knob 202 to select the design data update option 308. The user of the virtual watch device 200 then uses the control knob 202 to interact with the design data update menu 900 to modify watch component data for existing pre-set watch designs stored in the database 110 or to define watch component data for new watch designs

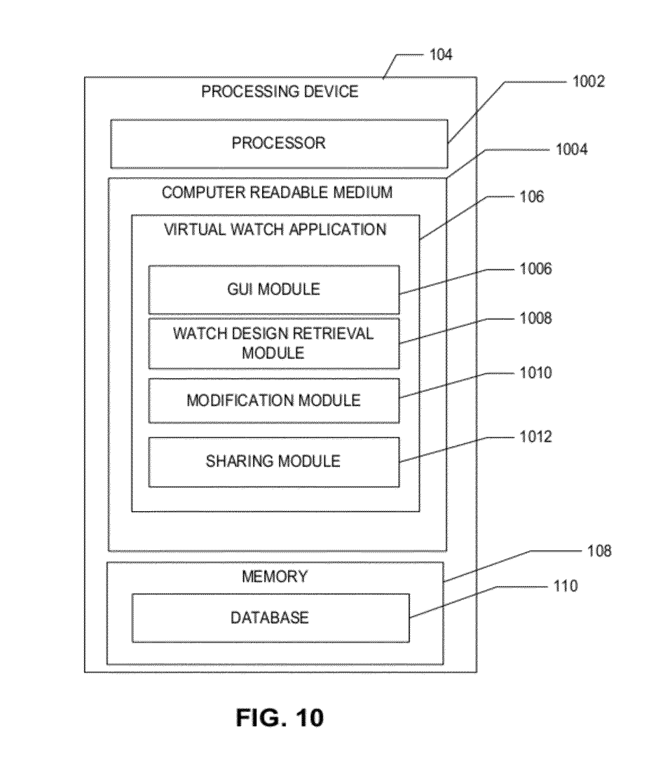

FIG. 10 is a block diagram illustrating the processing component 104. The processing component 104 includes a processor 1002 that executes the virtual watch application 106 which enables a user to display, modify, and/or create virtual watch designs.

According to one aspect, the processing component 104 includes a computer readable medium (“CRM”) 1004 configured with the virtual watch application 106. The CRM 1004 may include volatile media, nonvolatile media, removable media, non-removable media, and/or another available medium that can be accessed by the processing component 104. By way of example and not limitation, computer readable medium 1004 comprises computer storage media and communication media. Computer storage media includes memory, volatile media, nonvolatile media, removable media, and/or non-removable media implemented in a method or technology for storage of information, such as computer readable instructions, data structures, program modules, or other data. Communication media may embody computer readable instructions, data structures, program modules, or other data and include an information delivery media or system.

According to another aspect, the virtual watch application 106 includes instructions or modules that are executable by the processor 1002. Generally, program modules include routines, programs, objects, components, data structures, etc., that perform particular tasks or implement particular abstract data types. For example, in one embodiment, the virtual watch application 106 includes a GUI module 1006, a watch design retrieval module 1008, a modification module 1010, and a sharing module 1012 to view, modify, share, and create virtual watch designs. Other modules may also be included.

A GUI module 1006 generates various virtual watch menus (e.g., see menus 400, 500, 600, and 700) for display via the display screen 204. As described above, the user of the virtual watch device 200 interacts with the various virtual watch menus that can be displayed via the display screen 204 to create, modify, or share virtual watch design data stored in the database 110.

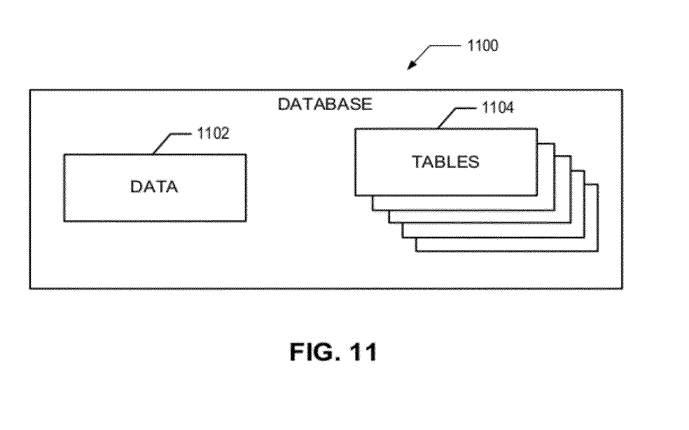

Referring briefly to FIG. 11, an exemplary database 110 is depicted. The database includes watch data 1102, such as pre-set virtual watch design and/or customized virtual watch design. The database also includes a plurality of tables 1104. Tables 1104 are for example, indexed by watch designs, such that each table corresponds to a particular watch design. Moreover, each table identifies the various modifiable components for the corresponding watch design and further identifies available features for each of the various components. For example, the table for the virtual watch design “classic” may list in rows all of the various modifiable components for the classic virtual watch design. The table may further include in a series of columns adjacent to each row that list the various component features that correspond to the modifiable component in that particular row.

Referring back, to FIG. 10, the GUI module 1004 is responsive to an input from a user of the virtual watch device 200 while a current watch design is being displayed to display the main menu 300 via the display screen 204. For example, during the display of a current watch design the user depresses the control knob to display the main menu. Alternatively, the user may double tap or perform some other gesture (e.g., by an input tool) on the display screen 112 during the display of the current watch design to display the main menu.

the GUI module 1004 is responsive to an input from a user of the virtual watch device 200 selecting a watch designs option control (e.g., watch design option 302) while the main menu 300 is being displayed to display a watch designs menu 400 via the display screen 204. In this example, the input corresponds to a user using the control knob 202 to highlight and select the watch designs option control. The watch designs menu 400 includes one or more controls that enable a user to retrieve all watch designs or particular watch designs from the database 110 for display via the display screen 204.

The watch design retrieval module 1006 retrieves watch design data from the database 110 for display via the display screen 204 in response to a retrieval request. The retrieval request is generated, for example, by the user selecting a particular one the controls on the menu 400. For example, the watch design retrieval module 1006 is responsive to the retrieval request corresponding to the selection of the classic control on the watch design menu 400 to retrieve classic watch design data from the database 110. The GUI module 1004 then displays the classic watch design on the display screen 204. In other aspects, the GUI module 1004 may display a list of classic watch design names from which a user can select a particular name to display the corresponding classic watch design on the display screen 204.

The modification module 1008 allows a user to store updated watch design data for existing watch designs in the database 110. The modification module 1008 is responsive to modification request from a user of the virtual watch device 200 to display a list of available watch designs on the display screen 204. The modification request is generated, for example, by the user using the control knob 202 to highlight and select a design data update option control (e.g., design data update option 302) while the main menu 300 is being displayed.

After the user selects a watch design from the list of available designs, the GUI module displays the component type selection menu 500. The user modifies the component feature type for the selected watch design by interacting with the watch component type selection menu 500 and modifies the component feature attributes for the selected watch by interacting with the feature attribute selection menu 504 to select one or more newly desired feature types and attributes, respectively, for various watch components. For example, a pre-set watch design may have a blue background, a metallic face, roman numerals, and a bezel. A user may modify the existing, pre-set metallic face of the watch design to a brushed steel face, while keeping the blue background, the roman numerals, and the bezel the same. Similarly, a user may modify the existing feature attributes of the watch design. The modification module 1008 receives the modified component feature type and/or attribute from the GUI module and is responsive to a storage request to store modified component feature type and/or feature attribute for the selected watch design in the database 110. The storage request is generated, for example, by the user selecting a save control (not shown).

The GUI module 1004 is responsive to a create request generated by a user of the virtual watch device 200 to display the component type selection menu 500. The create request is generated, for example, by the user using the control knob 202 to highlight and select the watch components option control (e.g., watch components option 304) while the main menu 300 is being displayed. The user creates a new watch design by interacting with the component type selection menu 500 to select one or more desired feature types for the various watch components and interacting with the feature attribute selection menu 504 to select one or more desired feature types for the various watch components. According to one aspect, if a user does not select a particular feature for a particular component (i.e., watch face, background, bezel, etc.) a default feature type is assigned to that particular component. The modification module 1008 is responsive to a storage request to store the new watch design in the database 110. The storage request is generated, for example, by the user selecting a save control (not shown) to view a save dialogue (not shown). As known to those of skill in the art, the save dialogue enables a user to specify a name for a file being saved.

The sharing module 1010 enables a user to share or transfer a watch design from the virtual watch device to a remote processing device, such as another virtual watch device 200. The GUI module 1004 is responsive to input an input from a user of the virtual watch device 200 selecting a design transfer option control (e.g., design transfer option 306) while the main menu 300 is being displayed to display the design transfer menu 406. The design transfer menu 406 enables users to select one or more watch designs for sharing. The sharing module 1010 is responsive to a transfer request to transmit the one or more selected watch designs to the remote processing device via the communication port 206. The transfer request is generated, for example, in response to the user selecting a transfer control (not shown) on the design transfer menu 406. According to one aspect, the sharing module 1010 may initiate transmission of watch designs in the form of image data from the communication port 206 over a cable connection, such as a universal serial bus (“USB”) cable, to the remote processing device.

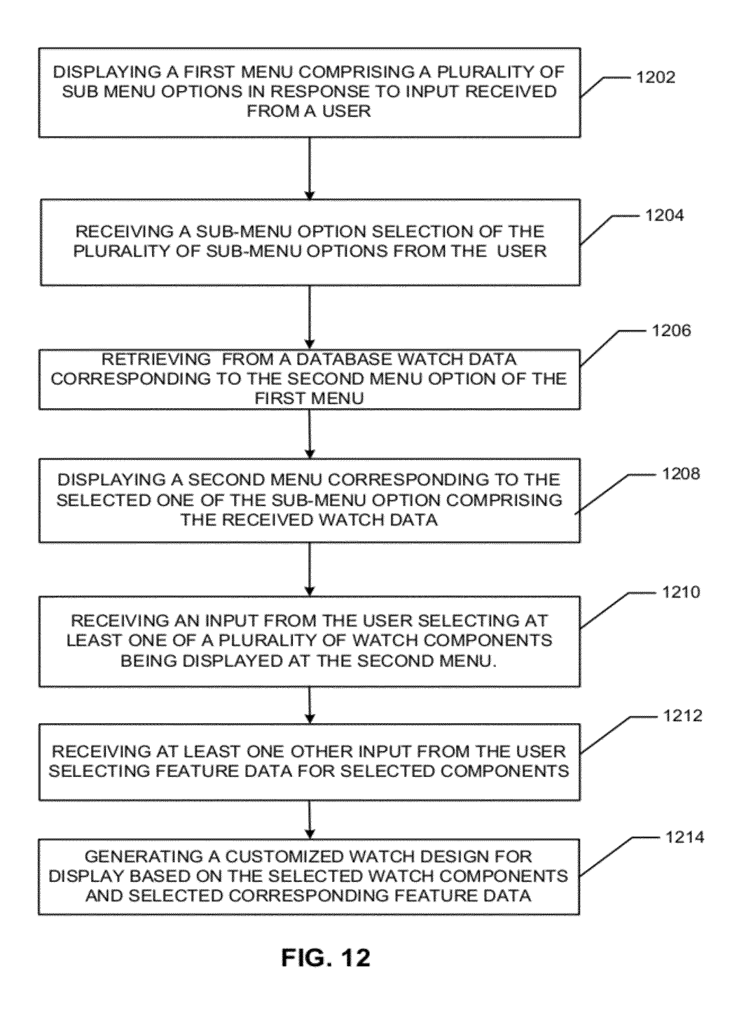

FIG. 12 illustrates a method for displaying a virtual watch design on the display 112. At 1202, a first menu comprising a plurality of sub menu options in response to input received from a user is displayed. A sub menu option selection of the plurality of sub-menu options is received from the user at 1204. At 1206, watch data corresponding to the second menu option of the first menu is retrieved from a database. At 1208 a second menu corresponding to the selected one of the sub-menu option comprising the watch feature data is displayed. At 1210, input selecting at least one of a plurality of watch components. At least one other input is received via other menus (e.g., menus 500, 600) selecting feature data (e.g., component type and/or component attributes) for selected components at 1212. At 1214, a customized watch design based on the selected watch components and the selected corresponding features is generated.

The description above includes example systems, methods, techniques, instruction sequences, and/or computer program products that embody techniques of the present disclosure. However, it is understood that the described disclosure may be practiced without these specific details.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium (e.g., floppy diskette), optical storage medium (e.g., CD-ROM); magneto-optical storage medium, read only memory (ROM); random access memory (RAM); erasable programmable memory (e.g., EPROM and EEPROM); flash memory; or other types of medium suitable for storing electronic instructions.

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

Those skilled in the art will appreciate that variations from the specific embodiments disclosed above are contemplated by the invention. The following invention should not be restricted to the above embodiments, but should be measured by the following claims.

What is claimed is:

1. A virtual watch apparatus for displaying a virtual watch design, the system comprising:
a housing;
a display screen;
at least one communication port operatively connected to the housing;
at least one processor;
at least one input device;
a memory storing watch design data for a plurality of watch designs, wherein each of the plurality of watch designs comprises a plurality of watch components, and wherein the watch design data comprises one or more watch feature types and one or more feature attributes for each of the plurality of watch components; and
a virtual watch application comprising modules executable by the at least one processor, the modules comprising:
a modification module to:
display a list of the plurality of watch designs via a graphical user interface at the display screen in response to an update request;
receive a first input corresponding to a first selection of a particular one of the plurality of watch designs being displayed;
receive a second input corresponding to a second selection of a feature type for at least one of the plurality of watch components of the particular watch design; and
receive a third input corresponding to a third selection of a feature attribute for each feature type selection;
store each feature type and each feature attribute selected for the particular watch design in the memory;
a watch design retrieval module to retrieve watch design data for the particular one of the plurality of watch designs from the memory in response to a retrieval request, the retrieval request identifying the particular watch design selected, each feature type selected, and each feature attribute selected; and
a GUI module to display the particular watch design selected with each selected feature type and each selected feature attribute via the graphical user interface.

2. The system of claim 1 wherein feature type is selected from a group consisting of a watch face, a background theme, a bezel type, an hour hand, a minute hand type, a second hand type, a numerical style type, a calendar, and hardware type.

3. The system of claim 1 wherein feature attribute is selected from a group consisting of a texture and a color.

4. The system of claim 1 wherein the list of watch designs comprises at least one of:
a classic design;
a luxury design;
a sporty design;
a current trend design; and
a tourbillion design.

5. The system of claim 1 wherein the at least one input device comprises a control knob operatively connected to the housing, and wherein the first selection of the particular one of the plurality of watch designs being displayed comprises:
rotating the control knob in a first direction or a second direction to highlight a desired watch design; and
depressing the control knob to select the desired watch design when highlighted.

6. The system of claim 5 wherein the first selection of the particular one of the plurality of watch designs being displayed comprises:
moving an input tool in an upward direction or an downward direction at the graphical user interface to display the desired watch design; and
tapping the input tool on the desired watch design to select the desired watch design.

7. The system of claim 6 wherein the GUI module is further configured to display a main menu via the graphical user interface in response to an initial input received while a current watch design is being displayed via the graphical user interface, the main menu comprising a plurality of controls, and wherein the update request is generated in response to a selection of a watch design control at the graphical user interface.

8. The system of claim 7 wherein the initial input is generated in response to the control knob being depressed.

9. The system of claim 7 wherein the initial input is generated in response to a gesture of an input tool on the display screen, the input tool consisting of at least one member selected from a group consisting of a stylus and at least one finger.

10. The system of claim 7 wherein the virtual watch application further comprises a sharing module to transfer a particular selected virtual watch design to a remote device in response to a transfer request, and wherein the transfer request is generated in response to a different selection of a design transfer control at the graphical user interface from the main menu.

11. The system of claim 10 wherein the particular selected virtual watch design is transferred to the remote device via a wired connection at the at least one communication port.

12. The system of claim 10 wherein the particular selected virtual watch design is transferred to the remote device wirelessly via a transmitter.

13. A method for displaying a virtual watch design via a virtual watch, the virtual watch comprising a housing, a display screen, a processing device, at least one input device, and at least one communication port, and the method comprising
retrieving a plurality of watch designs from a memory for display via in response to an update request;
displaying a list of the plurality of watch designs via a graphical user interface at the display screen in response to an update request;
receiving a first input corresponding to a first selection of a particular one of the plurality of watch designs being displayed;
receiving a second input corresponding to a second selection of a feature type for at least one of the plurality of watch components of the particular watch design; and
receiving a third input corresponding to a third selection of a feature attribute for each feature type selection;
storing each feature type and each feature attribute selected for the particular watch design in the memory;
retrieving watch design data for the particular one of the plurality of watch designs from the memory in response to a retrieval request, the retrieval request identifying the particular watch design selected, each feature type selected, and each feature attribute selected; and
displaying the particular watch design selected with each selected feature type and each selected feature attribute via the graphical user interface.

14. The method of claim 13 wherein the first selection of the particular one of the plurality of watch designs comprises:
rotating the at least one input device in a first direction or a second direction to highlight a desired watch design; and
depressing the at least one input device to select the desired watch design when highlighted.

15. The method of claim 13 wherein the first selection of the particular one of the plurality of watch designs comprises:
moving an input tool in an upward direction or an downward direction at the graphical user interface to display the desired watch design; and
tapping the input tool on the desired watch design to select the desired watch design.

16. The method of claim 13 further comprising displaying a main menu via the graphical user interface in response to an initial input received while a current watch design is being displayed via the graphical user interface, wherein the main menu comprises a plurality of controls, and wherein the update request is generated in response to a selection of a watch design control at the graphical user interface.

17. The method of claim 16 wherein the initial input is generated in response to the at least one input device being depressed.

18. The method of claim 16 wherein the initial input is generated in response to a gesture of an input tool on the display screen, the input tool consisting of at least one member selected from a group consisting of a stylus and at least one finger.

19. The method of claim 13 wherein further comprises transferring a particular selected virtual watch design to a remote device in response to a transfer request, and wherein the transfer request is generated in response to a different selection of a design transfer control at the graphical user interface from the main menu.

20. The method of claim 19 wherein transferring the particular selected virtual watch design comprises:
transferring the particular selected virtual watch design to the remote device via a wired connection at the at least one communication port; or
transferring the particular selected virtual watch design to the remote device wirelessly via a transmitter.

21. The method claim 13 wherein:
feature type is selected from a group consisting of a watch face, a background theme, a bezel type, an hour hand, a minute hand type, a second hand type, a numerical style type, a calendar, and hardware type; and
the feature attribute is selected from a group consisting of a texture and a color.
